(19) United States
(12) Patent Application Publication
(10) Pub. No.: US 2017/0174335 A1
(43) Pub. Date: Jun. 22, 2017

(54) ROTOR-LIFT AIRCRAFT

(71) Applicant: Malloy Aeronautics Ltd., Woking, Surrey (GB)

(72) Inventor: Christopher John Malloy, White Waltham, BERKSHIRE (GB)

(73) Assignee: Malloy Aeronautics, Ltd., Woking, Surrey (GB)

(21) Appl. No.: 15/129,732

(22) PCT Filed: Mar. 27, 2015
(86) PCT No.: PCT/GB2015/000103

§ 371 Date: Sep. 27, 2016

(30) Foreign Application Priority Data
Mar. 27, 2014 (GB) 1405553.7

(51) Int. Cl. B64C 27/08; B64D 35/04; B64D 27/24; B64C 27/20; B64C 29/00

(52) U.S. Cl. CPC B64C 27/08; B64C 27/20; B64C 29/0025; B64D 27/24; B64D 35/04

(57) ABSTRACT

A rotor-lift aircraft has at least two rotors 1, 2 mounted on spaced parallel axes A1, A2. The rotors rotate in use in planes in which the blade envelope subscribed by the tips of the blade(s) of each of the rotors overlaps with the blade envelope subscribed by the tips of the blade(s) of at least one other of the rotors without intermeshing of the blades.

### BACKGROUND

This disclosure relates to rotor-lift aircraft generally, including helicopters and VTOL/STOL aircraft.

A conventional helicopter employs a single main rotor to provide both lift and thrust and an anti-torque tail rotor to prevent the body of the aircraft rotating in a contrary sense to the main rotor to conserve angular momentum. While this configuration has proved extremely successful, numerous multi-rotor systems have also been proposed over the years. The tail rotor is responsible for many of the accidents to personnel, especially bystanders, caused by helicopters. Elimination of the tail rotor becomes feasible with multi-rotor systems where different rotors can rotate in opposite senses to cancel out the net angular momentum engendered by the rotors.

However, while many configurations for multi-rotor craft have been proposed over the years, with few exceptions, they have not proved successful.

In some multi-rotor systems, the blades intermesh, with potential risk of blade clash, which inevitably leads to a catastrophic accident, unless the respective rotors are driven synchronously from a common drive system as in the well-known CH-47 Chinook military helicopter. This requirement limits the ways in which thrust can be varied. Typically, this is by varying the pitch of the propellers, which involves complicated mechanisms like the swash plate featured on many helicopters. Increasing complexity involves increased cost, which for many years largely restricted multi-rotor configurations to military use.

Alternative arrangements, which avoid the need for synchronous drive by separating the rotors so that the blade tips no longer intermesh, have been used primarily for drones and for small scale electrically driven models. The construction may be much simpler, since variation of the speed of rotation of the different rotors can be used to vary thrust and change direction so that the propeller blades may have fixed pitch. Reduced capital and running costs makes multi-rotor craft potentially financially attractive to middle income individuals and small commercial users. However, the various multi-rotor configurations proposed heretofore have suffered from a significant drawback. Whether the aircraft consists of a miniature toy multicopter weighing a few grams or a larger scale multiple rotor passenger craft, such as an experimental two-seater 16-rotor design known as the “E-Volo”, there are storage and transportation problems. The aircraft needs to fit onto a trailer and into a garage or modest light industrial workspace.

The footprint of a rotor-lift aircraft including the envelope subscribed by the tips of its one or more rotors is determined both by the geometry of the one or more rotors and by the need for sufficient lift, since extended blades provide more lift for the same rate of rotation.

As will readily be understood, a single rotor two propeller conventional helicopter is most efficient in the space it takes up in a hangar since the single blade providing the two propellers may be aligned parallel to the longitudinal axis of the body. Even a conventional helicopter with a single rotor and three or more propeller blades has a substantial footprint for storage or transport unless the blades fold. Separating the rotors of a multi-rotor arrangement so that the blade tips no longer intermesh exacerbates the problem.

A related problem is that the footprint of the vehicle including the envelope subscribed by the tips of its one or more rotors determines the flight envelope which limits the gap between obstacles that the vehicle can negotiate.

### SUMMARY OF THE DISCLOSURE

The teachings of the present disclosure have arisen from our work seeking to provide practical rotor-lift aircraft that avoid, overcome or ameliorate the aforesaid problems.

In accordance with a first aspect of this disclosure, there is provided a rotor-lift aircraft with at least two rotors mounted on spaced parallel axes to rotate in use in parallel planes so that the blade envelopes subscribed by the tips of their blades overlap without intermeshing of the blades.

There need be no structure surrounding the rotor; but, in a preferred arrangement, the rotors are ducted.

In other words, each rotor may have a surrounding shroud with air inlet and outlet at opposite axial ends. Alternatively each rotor may have a surrounding cage, or merely an encircling bar serving as a guard to restrict the likelihood of the rotor blades making contact with a foreign body such as a bystander. In other arrangements, ducts may be formed as through openings in a wing or in a fuselage of the aircraft. All of these arrangements are to be included within the term “ducted” as used herein. Whatever structure is present to render the rotor ducted is referred to herein as “ducting”. The term “vehicle body” as used herein refers to the entire remainder of the vehicle apart from its rotor blades and ducting, and so will encompass a frame, chassis, fuselage or wings, when present, and the power source for driving the rotors.

In the most preferred arrangement, a rotor bearing for a first rotor is supported by ducting for a second rotor, and a rotor bearing for the second rotor is supported by ducting for the first rotor, thereby providing maximum blade envelope overlap.

As explained in more detail below, not only is this arrangement compact, enabling sufficient lift to be generated in a vehicle with a modest footprint, but by virtue of one rotor's bearing being supported by the ducting of another and vice-versa, the structure can be made more robust.

Preferably there are three or more rotors, and most preferably four rotors.

### BRIEF DESCRIPTION OF THE DRAWINGS

Reference may be made, by way of example, to the accompanying drawings, in which:

FIGS. 1 and 2 schematically illustrate a two rotor system embodying our teachings shown respectively in plan and in side elevation with other parts of the vehicle omitted for clarity;

FIGS. 3 and 4 schematically illustrate a triple rotor system on a similar basis;

FIGS. 5 and 6 similarly illustrate a quadruple rotor system;

FIGS. 7 and 8 show an alternative quadruple rotor system;

FIGS. 9 and 10, 11 and 12, and 13 and 14 show three alternative triple rotor systems;

FIGS. 15 and 16 illustrate, on a similar basis, how two spaced double rotor systems may be applied to a vehicle body indicated schematically;

FIGS. 17 and 18, and 19 and 20 similarly respectively illustrate how two spaced triple rotor and quadruple rotor systems may be applied to a vehicle body;

FIGS. 21 and 22 illustrate how two multiple inline rotor systems may be applied to a vehicle body;

FIGS. 23 and 24, 25 and 26, 27 and 28, and 29 and 30 illustrate how increasing numbers of rotors may be arranged with multiple overlap in curved configurations in plan;

FIG. 31 is a perspective view of a an embodiment of vehicle with the rotor configuration of FIGS. 15 and 16, together with rider;

FIGS. 32 and 33 are plan and side elevational views of the vehicle and rider of FIG. 31;

FIG. 34 is a perspective view schematically illustrating how drive is applied to the four rotors of the vehicle of FIGS. 31 to 33; and

FIG. 35 is a perspective view similar to FIG. 34 for an alternative drive arrangement.

### DESCRIPTION OF PREFERRED EMBODIMENTS

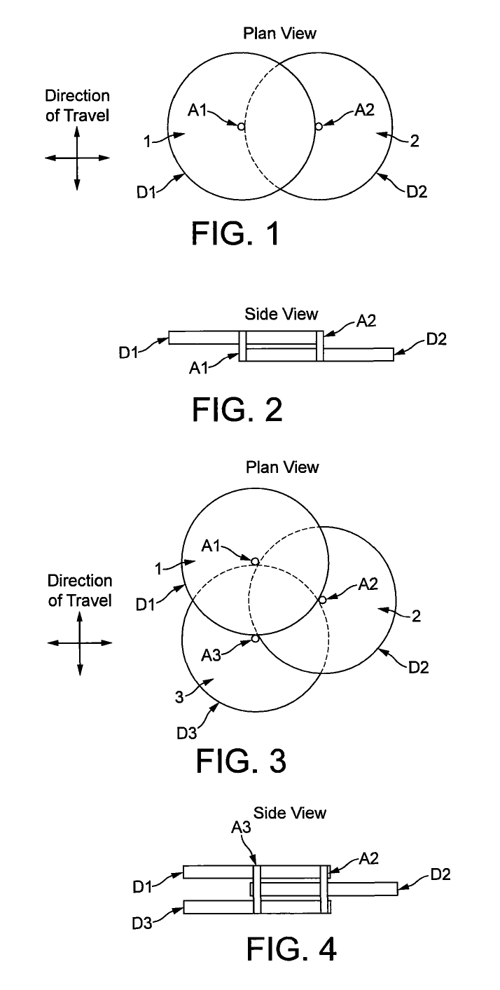

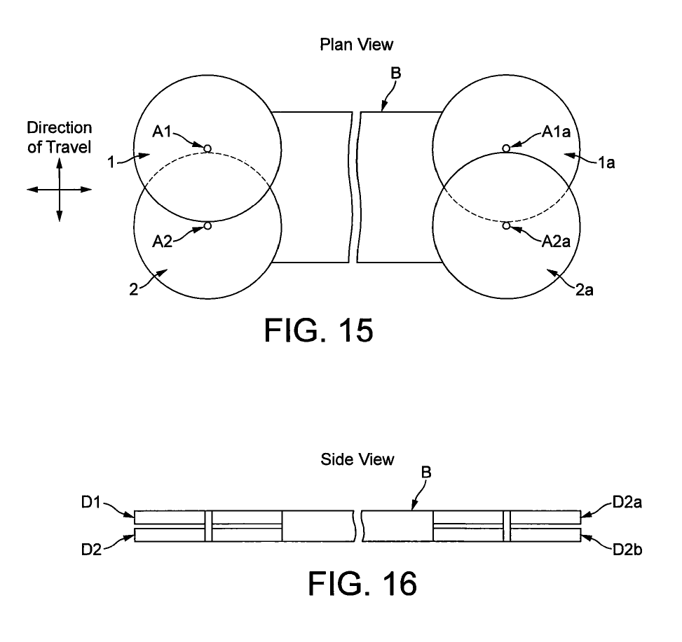

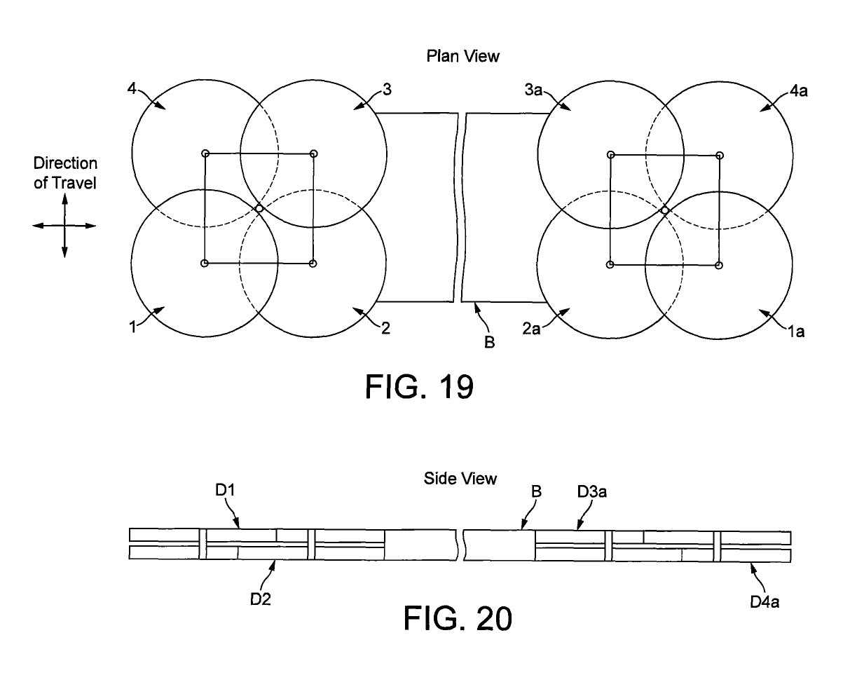

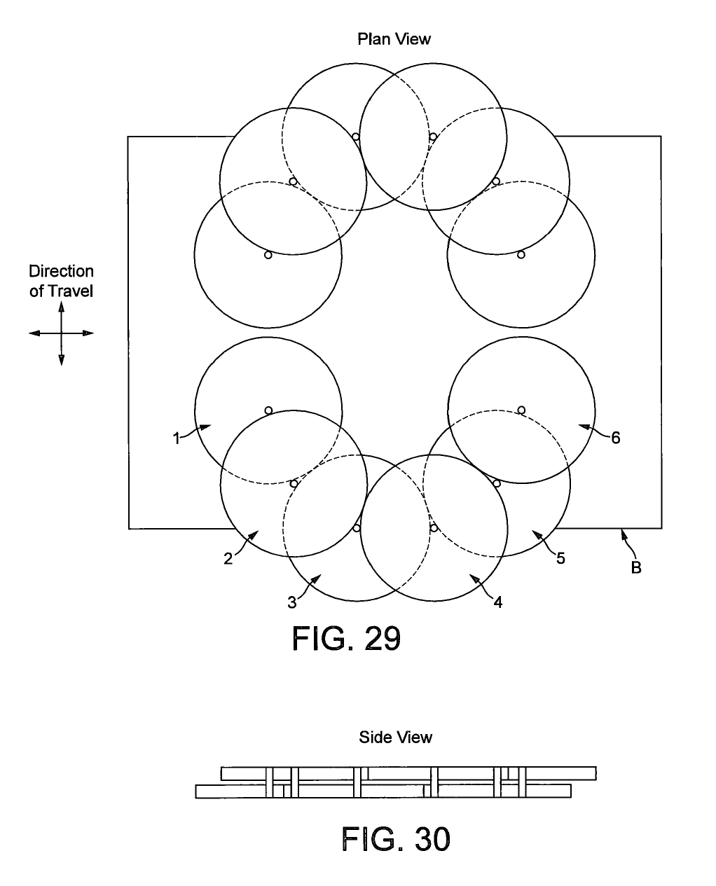

FIGS. 1 to 30 illustrate various configurations for the rotor blades in arrangements with ducted rotors where the ducting is provided by a shroud. It will readily be understood that the same configurations could be employed with other forms of ducting, as described hereinbefore, or in arrangements without any ducting. These Figures are essentially schematic, with the blades or propellers of the respective rotors omitted for clarity, so that all that is visible is the ducting and rotor axes, and, in the case of FIGS. 15 to 30, a schematically illustrated vehicle body.

Thus in the simplest arrangement of FIGS. 1 and 2, two rotors 1 and 2 rotate about spaced parallel axes A1 and A2 in parallel planes so that the blade envelopes subscribed by the tips of their blades overlap without intermeshing of the blades. Rotors 1 and 2 are ducted, rotor 1 having axis A1 and ducting D1, and rotor 2 having axis A2 and ducting D2. It will be understood, that in the conventional arrangement for ducted rotors, the blade tips of the propellers or blades will rotate within their respective ducting with only a small clearance between the blade tips and the inner wall of the ducting. It will be seen that a rotor bearing for axis A1 is supported by ducting D2, while a rotor bearing for axis A2 is supported by ducting A1, thereby providing maximum blade envelope overlap.

The preferred direction for forward flight of a vehicle fitted with the rotor arrangement of FIGS. 1 and 2 may be any of the four directions shown at the left of FIG. 1. Preferred directions for forward flight are also shown in each of FIGS. 3, 5, 7, 9, 11, 13, 15, 17, 19, 21, 23, 25, 27 and 29.

A triple overlap is provided in the triple rotor arrangement of FIGS. 3 and 4, in which the axes and ducting for rotors 1, 2 and 3 are numbered in a similar fashion to FIGS. 1 and 2. In this arrangement each rotor bearing is supported by the ducting of each of the other two rotors.

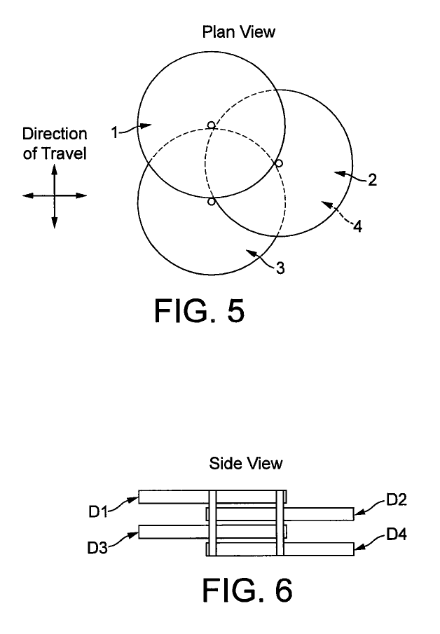

FIGS. 5 and 6 show a first arrangement involving four rotors, in which rotors 1, 2 and 3 have the same configuration as the rotors of FIGS. 3 and 4, while a further rotor 4 is mounted on the same axis as rotor 2.

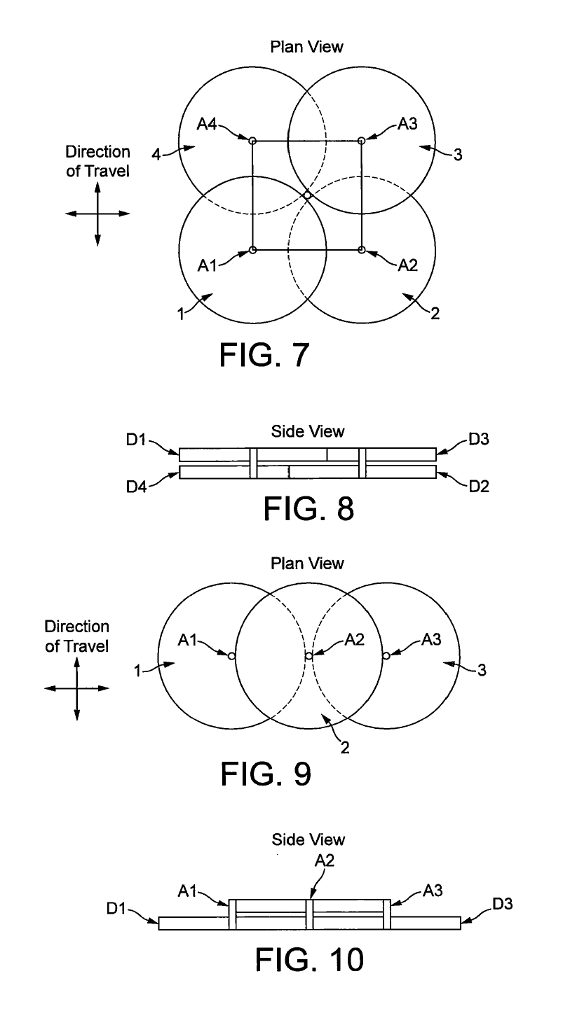

It will be noted that the rotors of FIGS. 3 and 4 rotate in three parallel planes and that the rotors of FIGS. 5 and 6 rotate in four parallel planes. FIGS. 7 and 8 show an alternative to the arrangement of FIGS. 5 and 6 which reduces the number of parallel planes to two at the expense of a slightly increased footprint. In this arrangement, each rotor bearing is no longer supported by the ducting of at least one other rotor. However, the four ductings D1, D2, D3 and D4 have a common central support S.

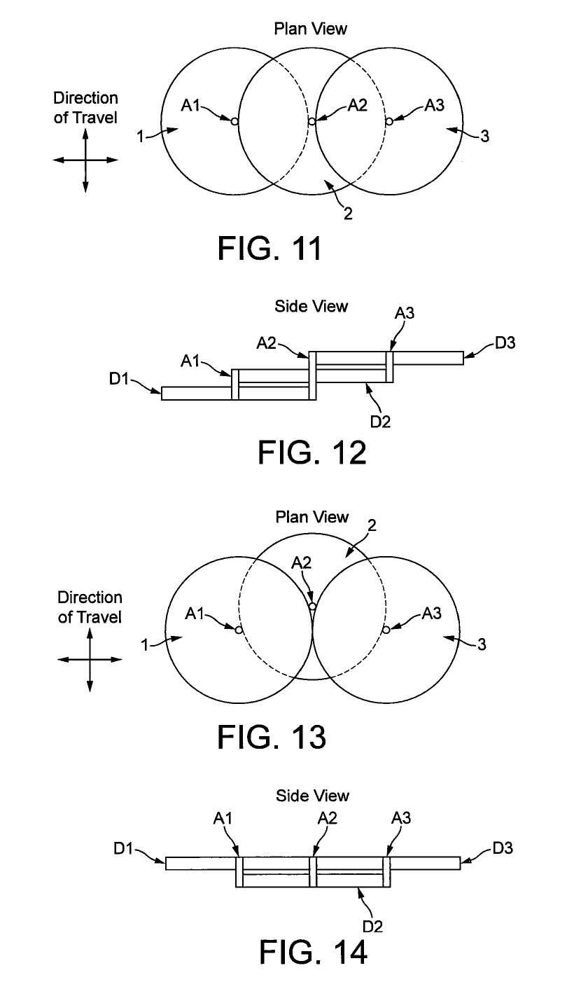

Inline overlap with each rotor bearing supported by the ducting of at least one other blade in maximum overlap configurations can be accomplished with the rotors arranged in two parallel planes, as shown in FIGS. 9 and 10, or in multiple planes as shown in FIGS. 11 and 12. Rather than being strictly inline, the rotors may be arranged in a curved layout as shown in FIGS. 13 and 14. This configuration is particularly suitable when the rotors are mounted inside wings and/or a fuselage of the vehicle, thereby providing a novel form of VTOL aircraft suitable for long-range use, with the rotors providing lift on take-off and landing.

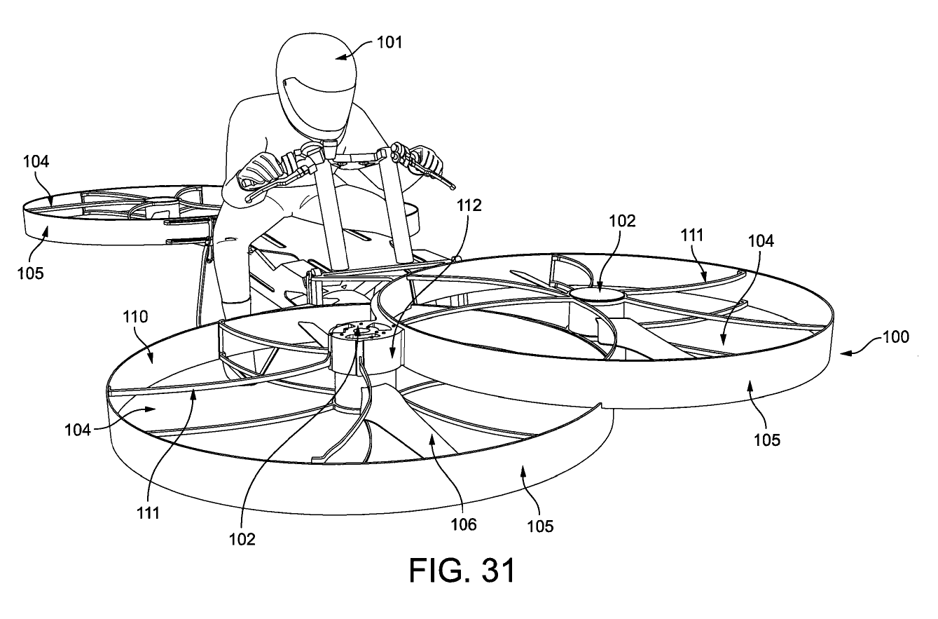

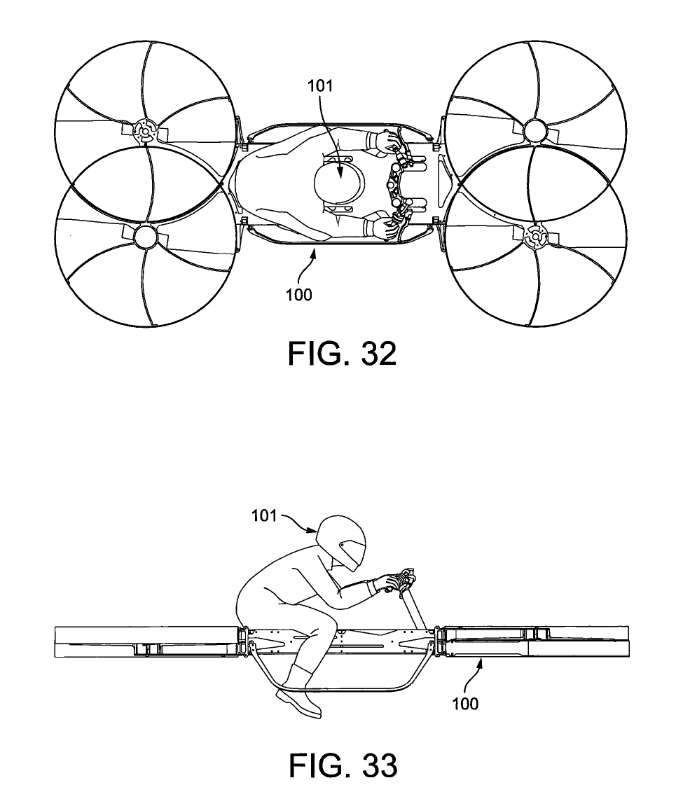

Two pairs of rotors 1, 2 and 1a, 2a may be mounted relative to a vehicle body schematically indicated at B, as shown in FIGS. 15 and 16. The most preferred direction for forward travel will be left or right in FIG. 15. It will be seen that rotors 1 and 2a rotate in the same plane while rotors 2 and 1a rotate in a parallel plane. The configuration of FIGS. 15 and 16 is our preferred configuration for a hoverbike, as described further below with reference to FIGS. 31 to 35.

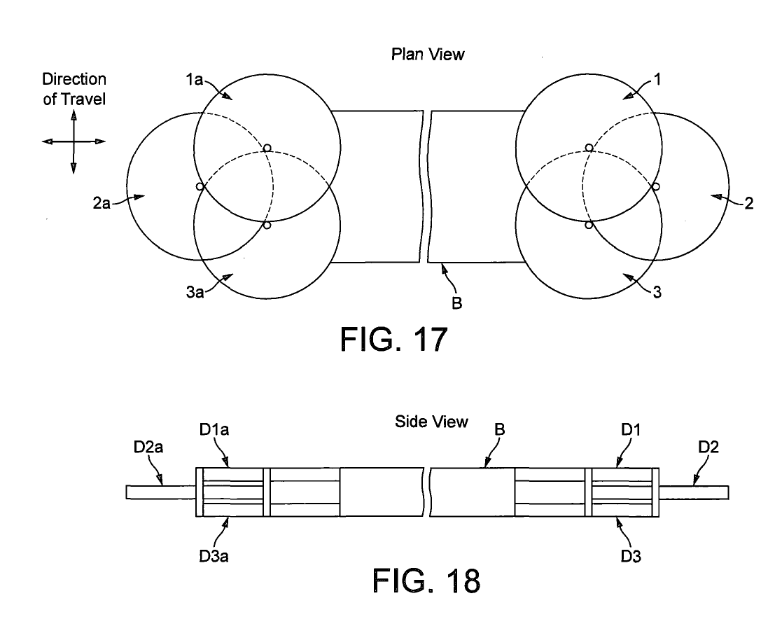

As shown in FIGS. 17 and 18 and FIGS. 19 and 20, respectively, the configurations of FIGS. 3 and 4 and of FIGS. 7 and 8 also lend themselves to provision in pairs, generally mounted fore and aft on a body B.

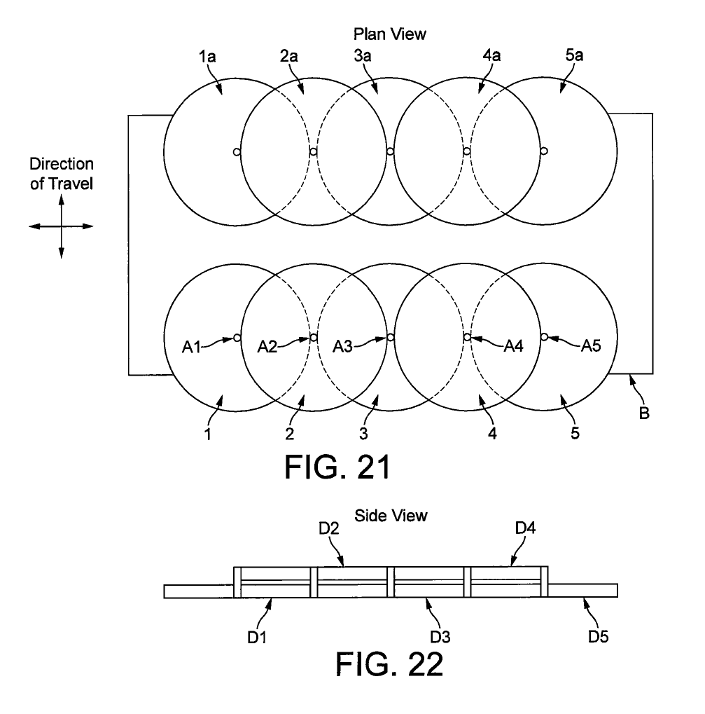

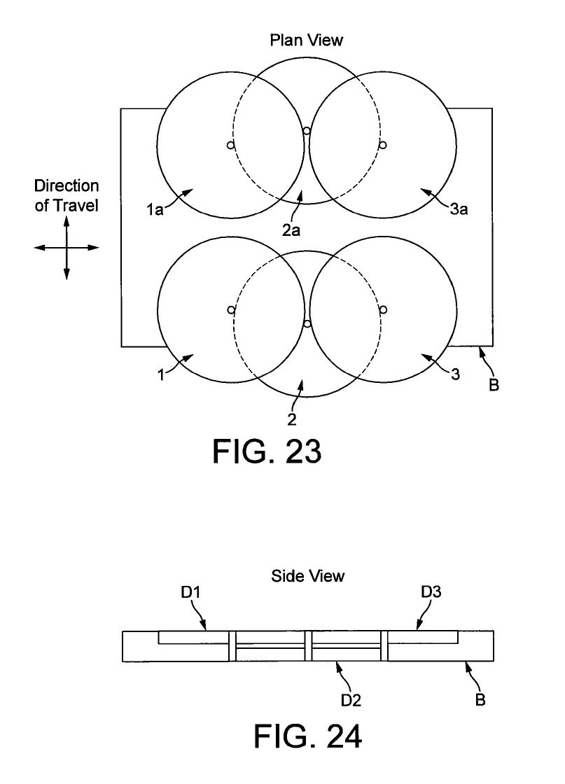

A body B may also be provided with multiple inline overlapped rotors on either side of the body, as shown in FIGS. 21 and 22. Curved arrangements of rotors as in FIGS. 13 and 14 may be similarly employed as shown in FIGS. 23 and 24. These arrangements lend themselves to multiple use vehicles adapted both for conventional road use without the rotors turning, and for use in the air, for transporting cargo and/or a number of passengers.

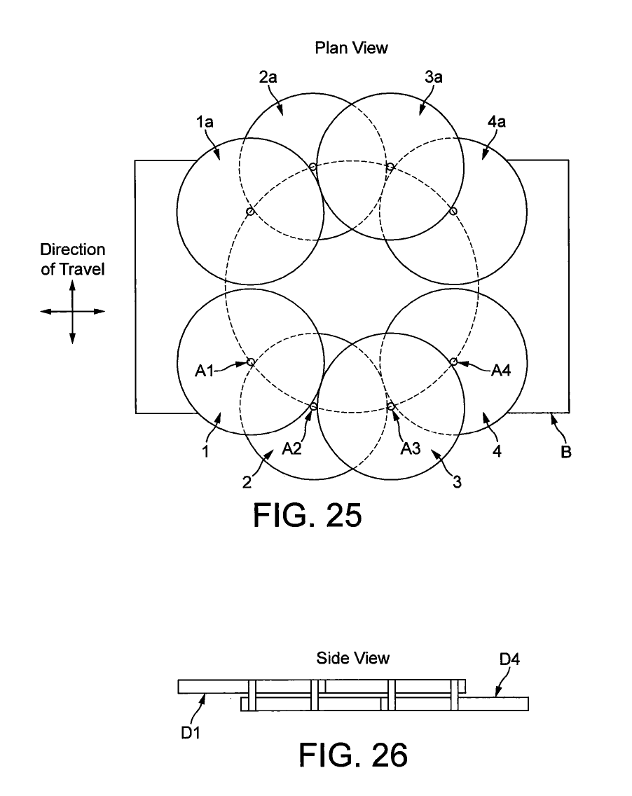

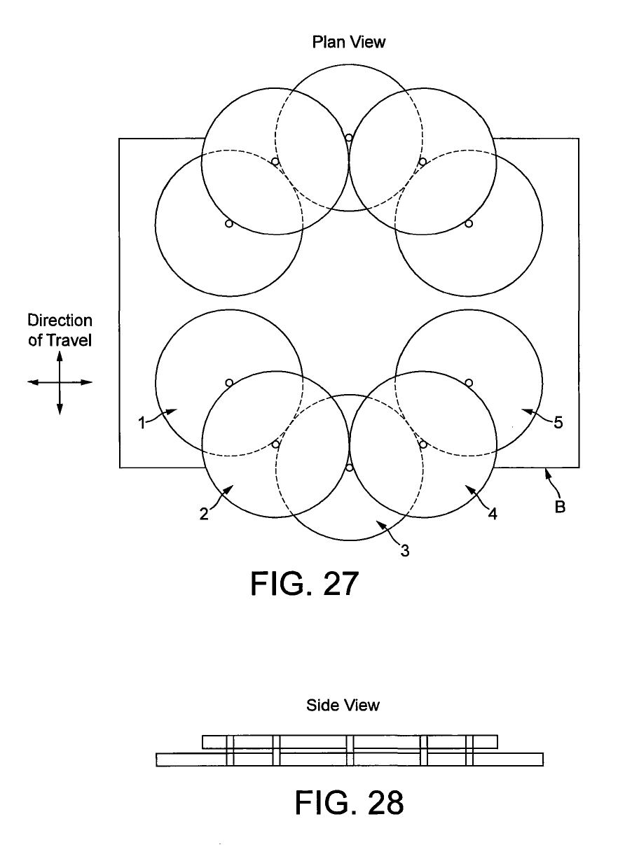

FIGS. 25 and 26 show how a number of rotors, here eight, may be arranged with their respective rotors on a circle. Even greater numbers of rotors with maximum overlap between each rotor and its neighbour or neighbours can be arranged on a body B, with the respective rotors rotating in just two planes, as shown in the arrangements of FIGS. 27 and 28 and FIGS. 29 and 30.

Reference may now be made to FIGS. 31 to 35 which show how the schematic arrangement of FIGS. 15 and 16 may be applied to a vehicle 100 in the form of a hoverbike, namely a vehicle in which a rider 101 sits in a stance similar to that of a motorcycle, and in which lift and forward thrust are provided by rotors mounted fore and aft of the rider. The provision of a practical embodiment of hoverbike has long been the goal of designers of multiple rotor vehicles. While there have been a number of previous proposals, these have generally not proved successful. They have experienced problems in delivering an adequate thrust to planform ratio, where planform is the area of the total footprint of the rotors, and so use a disproportionate amount of power, with the result that, even when they have flown, flight has usually not got beyond scale models.

The teachings of the present disclosure make a major contribution to bringing this goal to fruition.

Previous attempts to provide multiple rotor vehicles concentrated on avoiding intermeshing of blades by separating them sufficiently in the same plane so that they did not intermesh. Once this is achieved, the rotors may rotate at different speeds to provide control of the vehicle. Arrangements in accordance with the present teachings achieve a reduction of planform as compared with the most efficient of prior arrangements with minimal blade tip clearance that is proportional to the extent of overlap.

Consider a conventional model quad-copter with four identical two-bladed propellers with a diameter of 0.3 m and propeller blades rotating in the same plane with minimum tip clearance, creating a vehicle just over 0.6 m wide. In flight this quad-copter can only pass between objects more than 0.6 m apart. The ratio of thrust to planform can be expressed as:

R=Tₜₕᵣᵤₛₜ/(A_{disk}*P_{number})

where A_{disk}=area of the rotor envelope and P_{number}=number of propellers.

For a thrust of 100N, the ratio R=83.3 for the aforementioned quad-copter.

If the rotors are overlapped at close to 50% such that the arc subscribed by the tip of one propeller intercepts near the axis of the adjacent propeller, then:

R=Tₜₕᵣᵤₛₜ(((2*A_{disk})−(A_{disk}*Rₒᵥₑᵣₗₐₚ))*0.5*P_{number})

where Rₒᵥₑᵣₗₐₚ=the percentage of overlap expressed as a decimal.

With the same rotor diameter and the same performance, the ratio R=111.1, which is 34% more thrust for the same planform area.

Put another way, for the same thrust using rotors of the same size, the planform is significantly reduced, with significant aerodynamic advantage. With close to 50% overlap, as in the hoverbike 100 of FIGS. 31 to 35, the width of the aircraft is reduced by approximately the length of one propeller, significantly reducing drag during forward flight, thereby allowing improved range and speed. Because the resultant aircraft is smaller, it is also lighter in weight, making it less expensive to construct. Lighter weight equates to greater fuel efficiency and further improved range.

Moreover, by supporting a secondary drive 102 or gearing 103 for each rotor 104 on the ducting 105 of another rotor in the maximum overlap configuration, there is a further reduction in material costs and reduction in mass because one or more structural supports from the airframe may be omitted without compromising integrity.

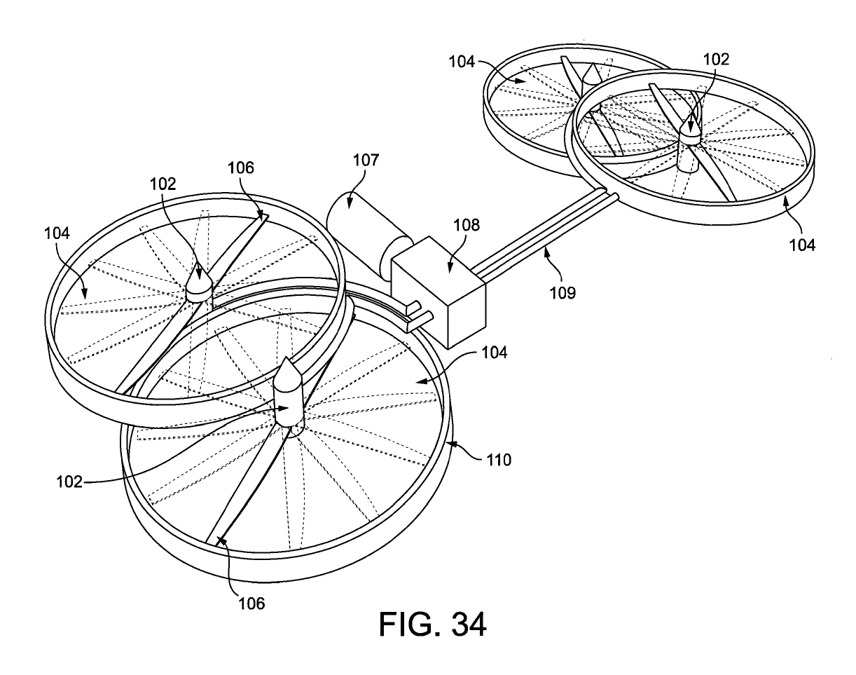

For ease of illustration in FIGS. 31 to 35, two-bladed propellers 106 are shown. However, in practice the rotors will typically have more than two propeller blades. FIGS. 31 and 34 show a preferred drive system. A prime mover motor 107 is connected to one or more generators 108 to generate electricity. Electric cables 109 carry power from the generator/s to secondary drive motors 102 associated with each rotor. These secondary drive motors 102 drive the propellers 106, which are mounted inside respective ducts 110. The ducts support the respective secondary drive motors and thus the rotor bearings. A number of struts 111 support the ducts from the rotor hubs. The relative solidity of the ducts 110 as compared with the struts 111 and the fact that the ducts are directly coupled to casings 112 for the secondary drive motors, increases both strength and rigidity of the structure as a whole. The prime mover motor 107 is preferably a liquid fuel motor such as a petrol or diesel internal combustion engine, and the secondary drive motors 102 comprise electric motors.

In a variant arrangement, also illustrated by FIG. 34, the prime mover motor 107 drives one or more hydraulic pumps, which are connected by hydraulic hoses as opposed to electric cables to secondary drive motors 102, which in this case will be hydraulic motors.

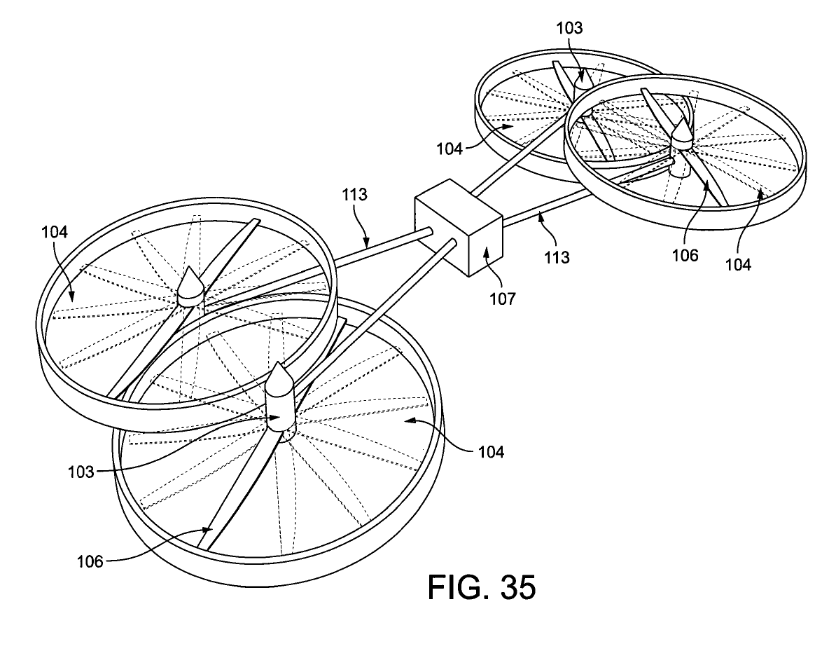

In other variants schematically illustrated in FIG. 35, prime mover motor 107 drives the rotors by a mechanical coupling 113, which may be chain, fan belt or drive shaft via one or more gearboxes, culminating in a gearbox 103 at the axis of each rotor. The drive system then powers/spins the rotors that are mounted in each duct.

Control of the craft is not dissimilar to that of a helicopter. In order to move forwards from a hover, the craft is leaned forward such that the rear of the craft is raised relative to the front, which can be achieved by briefly increasing the speed of the rear pair of rotors relative to the front pair. To move backwards, or decelerate whilst in forward flight, the front of the craft is raised relative to the rear, again by adjusting the speed of one pair of rotors relative to the other. The craft will begin to accelerate in the direction in which it is leaning, or decelerate from its original direction of movement, so long as that angle is maintained.

While in a hover, to move the craft to the left, the pilot briefly increases speed of the rotors on the left side of the vehicle. This causes the craft to lean to the right, and the craft will then move to the right. To move to the left, the pilot briefly increases power to the rotors on the right.

In order to turn right whilst in forward flight, the pilot initially increases power to the left hand side rotors, and then as the craft is leaning to the right, the pilot will increase power to the forward rotors, “lifting” the front of the craft relative to its attitude in the air, thereby “pulling” the craft through a right hand turn. A left turn is achieved by the same method, increasing power to the right side rotors and then increasing power to the front rotors, such that the craft will move around to the left.

This method of control is only possible because each rotor, whilst overlapping with another, does not intermesh with the blades from another or other rotor/s in direct proximity to it. Each rotor is prevented from striking another spinning directly above or below it by its structural design. The rotor blades are sufficiently stiff, and their horizontal separation sufficiently distant, that no conditions other than a catastrophic accident with another body would allow any of the blades in the rotor systems in question to strike each other whilst moving.

It is therefore possible to increase or decrease the speed of each rotor relative to each other rotor because adjoining rotors do not intermesh. This capacity to spin adjoining rotors at different speeds allows a ready means of steerage and flight control of the craft.

We have found that mounting the rotors inside ducts improves power efficiency. Ducting also serves as a safety feature, creating a solid barrier between the spinning rotors and anything or anyone that gets too close to the rotors as they spin. Also, as explained above, the dual ducts provide efficient structural support for the secondary drive motors, or gearboxes, mounted at the hub of each propeller.

Arrangements that replace shroud-type ducting with a simple safety cage or a safety bar encircling the rotors reduce the mass of the vehicle and so require virtually no additional lift over the equivalent arrangement without any ducting and create minimal drag. Nevertheless, these arrangements still serve a safety function, which may be combined with lightweight mesh above and below each rotor to prevent entry of foreign bodies such as birds, and, by providing additional support for motors, gearboxes and bearings for the rotors, strengthen the aircraft.

1-15. (canceled)

16. A rotor-lift aircraft with at least two rotors mounted on spaced parallel axes to rotate in use in planes in which the blade envelope subscribed by the tips of the blade(s) of each of the rotors overlaps with the blade envelope subscribed by the tips of the blade(s) of at least one other of the at least two rotors without intermeshing of the blades; the rotors being ducted, each of said at least two rotors being provided with respective ducting structure radially outwardly of its blade tips; the at least two rotors having the same radius, and wherein one rotor of said at least two rotors has a first rotor bearing supported by ducting structure associated with another of said at least two rotors, while the said another rotor of said at least two rotors has a second rotor bearing supported by ducting structure associated with the said one rotor, whereby the respective blade envelopes of said one and said another rotors overlap by a distance less than but approaching the radius of their blades.

17. An aircraft according to claim 16, wherein the respective ducting structure comprises a surrounding shroud defining an air inlet to the rotor and an air outlet from the rotor at opposite ends of the shroud.

18. An aircraft according to claim 16, wherein the ducting structure is provided in the form of a guard for each of said at least two rotors, the guard being selected from a surrounding cage and an encircling bar, and being adapted to reduce the likelihood of a said rotor when turning making contact with a foreign body such as a bystander.

19. An aircraft according to claim 16, further comprising a vehicle body in which the at least two rotors are mounted, the ducting structure being defined within at least one through opening in the vehicle body.

20. An aircraft according to claim 16, wherein the aircraft has a power source, comprising: a prime mover, respective secondary drive means associated with each said rotor, and power connections between the prime mover and each said secondary drive means.

21. An aircraft according to claim 20, wherein the prime mover is coupled to a generator; and wherein the secondary drive means comprise respective secondary electric motors coupled to the generator, each said motor being associated with a respective rotor for driving the same.

22. An aircraft according to claim 20, wherein the prime mover is coupled to one or more hydraulic pumps; and wherein the secondary drive means comprise respective hydraulic motors coupled to the one or more hydraulic pumps, each hydraulic motor being associated with a respective rotor for driving the same.

23. An aircraft according to claim 20, wherein the respective secondary drive means comprise respective gearboxes at the axis of each rotor; and wherein the prime mover is coupled to the respective secondary drive means by a mechanical coupling selected from at least one of chains, belts and drive shafts, optionally via one or more intermediate gearboxes.

24. An aircraft according to claim 16, further comprising a vehicle body, and at least one power source for the at least two rotors; the vehicle body mounting the at least two rotors and the at least one power source so that the rotors when powered by the at least one power source may provide lift to the aircraft; and the vehicle body comprising at least one of a fuselage and wings, and optionally further comprising one or both of a frame and chassis, and the vehicle body defining at least one through opening providing the ducting structure for the at least two rotors, the ducting structure defining for each said rotor an air inlet to the rotor and an air outlet from the rotor at opposite ends of a said through opening in the vehicle body.

25. An aircraft according to claim 16, wherein there are four said rotors, the aircraft being a hoverbike defining a medial plane that includes the vertical when the aircraft is in a stationary hover mode, the medial plane defining a principal direction of travel; wherein a seat for a pilot to sit thereastride is positioned in the medial plane facing forwardly in the principal direction of travel; wherein two said rotors are mounted with their axes forwardly of the seat and on either side of the medial plane and with their rotors mounted on spaced axes parallel to each other and to the medial plane to rotate in use in parallel planes so that the blade envelopes subscribed by the tips of their blades overlap without intermeshing of their blades; and wherein the other two said rotors are mounted with their axes rearwardly of the seat and on either side of the medial plane and with their rotors mounted on spaced axes parallel to each other and to the medial plane to rotate in use in parallel planes so that the blade envelopes subscribed by the tips of their blades overlap without intermeshing of their blades.

26. An aircraft according to claim 16, wherein there are an even number of rotors in excess of two, the rotors being divided into two symmetrical spaced groups of equal number, the aircraft having a principal direction of travel selected from the direction in which the groups are spaced from each other and a direction perpendicular to the direction in which the groups are spaced from each other, and the rotors of each group being mounted on spaced parallel axes to rotate in planes in which the blade envelope subscribed by the tips of the blade(s) of each of the rotors of that group overlaps with the blade envelope subscribed by the tips of the blade(s) of at least one other of the rotors of that group without intermeshing of the blades.

27. An aircraft according to claim 25, wherein the rotors of each group rotate in two parallel planes, adjacent rotors in the group rotating in alternate ones of the two planes.

28. A hoverbike comprising a rotor-lift aircraft having: an aircraft body defining a medial plane that includes the vertical when the aircraft is in a stationary hover mode, the medial plane defining a principal direction of travel; a seat for a pilot to sit thereastride positioned in the medial plane and facing forwardly in the principal direction of travel; a first pair of rotors mounted with their axes forwardly of the seat and on either side of the medial plane and with their rotors mounted on spaced axes parallel to each other and to the medial plane to rotate in use in parallel planes so that the blade envelopes subscribed by the tips of their blades overlap without intermeshing of their blades; a second pair of rotors mounted with their axes rearwardly of the seat and on either side of the medial plane and with their rotors mounted on spaced axes parallel to each other and to the axes of the rotors of the first pair to rotate in use in parallel planes so that the blade envelopes subscribed by the tips of their blades overlap without intermeshing of their blades;
and a power source, comprising a prime mover, respective secondary drive means associated with each said rotor, and power connections between the prime mover and each said secondary drive means.

29. An aircraft according to claim 28, wherein the prime mover is coupled to a generator; and wherein the secondary drive means comprise respective secondary electric motors coupled to the generator, each said motor being associated with a respective rotor for driving the same.

30. An aircraft according to claim 28, wherein the prime mover is coupled to one or more hydraulic pumps; and wherein the secondary drive means comprise respective hydraulic motors coupled to the one or more hydraulic pumps, each hydraulic motor being associated with a respective rotor for driving the same.

31. An aircraft according to claim 28, wherein the respective secondary drive means comprise respective gearboxes at the axis of each rotor; and wherein the prime mover is coupled to the respective secondary drive means by a mechanical coupling selected from at least one of chains, belts and drive shafts, optionally via one or more intermediate gearboxes.
